(19) United States
(12) Patent Application Publication
(10) Pub. No.: US 2024/0139908 A1
(43) Pub. Date: May 2, 2024

(54) DEVICE FOR CONTROLLING A SPINDLE OF A GRINDING MACHINE, ASSOCIATED METHOD AND ASSOCIATED GRINDING MACHINE

(71) Applicant: SKF Magnetic Mechatronics, Saint-Marcel (FR)

(72) Inventors: Francis BIENAIME, Mont-Saint-Aignan (FR); Yannick Paul, Vernon (FR); Sylvain Palmeri, Angerville la campagne (FR); Gerald AUBÉ, Miserey (FR)

(21) Appl. No.: 18/487,463

(22) Filed: Oct. 16, 2023

(30) Foreign Application Priority Data
Oct. 27, 2022 (FR) 2211181

(51) Int. Cl. B24B 51/00; B24B 41/04; F16C 32/04

(52) U.S. Cl. CPC B24B 51/00; B24B 41/044; F16C 32/0451

(57) ABSTRACT

A device (21) for controlling a spindle of a grinding machine (1) is disclosed. The spindle includes a rotor (5) supported by two radial magnetic bearings, one axial bearing, and a grinding wheel (6). The device includes a storage means (22) for storing control coefficients of the magnetic bearings. The device includes a means for determining a type of the grinding wheel and a type of the rolling bearing ring. A selection means (23) selects control coefficients associated with the determined types of grinding wheel and of rolling bearing ring from among the control coefficients stored in the storage means. The device also includes a means (23) for controlling the radial and axial magnetic bearings. Said means controlling the radial and axial (12) magnetic bearings on the basis of the control coefficients of the determined types of grinding wheel and of rolling bearing ring.

### CROSS-REFERENCE TO RELATED APPLICATION

This application claims priority to French Application No. 2211181, filed Oct. 27, 2022, the entirety of which is hereby incorporated by reference.

### FIELD

The present disclosure relates to the control of grinding machines.

The present disclosure relates, more particularly, to a device for controlling a spindle of a grinding machine comprising a rotor supported by magnetic bearings, to a grinding machine comprising such a device, and to a control method for operating part of said device.

### BACKGROUND

A grinding machine conventionally comprises a table that is able to move along three axes and supports a spindle.

The spindle comprises an electric motor that drives a rotor in rotation, one of the ends of said rotor being equipped with a grinding wheel, which may in particular be used to grind ball bearing rings.

The rotor of the spindle is maintained in rotation in a grinding machine stator using ball bearings.

In order to increase the rotational speed of the spindle so as to increase the productivity of the grinding machine, the rotor is maintained in rotation using magnetic bearings.

However, it has been found that the forces acting on the rotor vary during phases of dressing the grinding wheel and during phases of grinding the rings.

Furthermore, it has been found that the forces acting on the rotor vary depending on the type of ring.

The geometric quality of the ground surfaces of the rings is directly impacted by the dynamics of the rotor, which is controlled by the magnetic bearings, of the spindle.

It is therefore proposed to overcome all or some of these disadvantages by taking the use phase of the spindle and the type of ring into consideration for the driving of the magnetic bearings.

### SUMMARY

In light of the above, the present disclosure proposes a method for controlling a spindle of a grinding machine comprising a rotor supported by two radial magnetic bearings and one axial bearing, the rotor comprising a grinding wheel for grinding a raceway of a rolling bearing ring, the method comprising a step of determining the type of the rolling bearing ring.

The method further comprises:
a step of selecting a set of control coefficients of the magnetic bearings associated with the types of rolling bearing ring determined from among a plurality of sets of control coefficients of the magnetic bearings, each set of control coefficients of the magnetic bearings being associated with a different type of grinding wheel and of rolling bearing ring, and comprising a first list of control coefficients and a second list of control coefficients,
   a dressing step, which comprises dressing the grinding wheel using a dressing tool, the magnetic bearings being controlled on the basis of the coefficients of the first list of control coefficients associated with the set of coefficients of the determined type of the grinding wheel and of the rolling bearing ring, and
   a step of grinding the raceway of the rolling bearing ring using the dressed grinding wheel, the magnetic bearings being controlled on the basis of the coefficients of the second list of control coefficients associated with the set of coefficients of the determined type of rolling bearing ring.

Selecting the control coefficients of the bearings depending on the nature of the operation being carried out (dressing or grinding) makes it possible to adapt the driving of the magnetic bearings to the specific forces produced by each of the operations, which makes it possible to optimize the precision with which the rotor is guided and, as a result, makes it possible to increase the quality of the operation of grinding the rolling bearing ring.

Preferably, the method comprises:
a step of installing a new rolling bearing ring of a type that is different to the type of the rolling bearing ring determined during the step of determining the type of rolling bearing ring,
repeating the selection step in order to select the set of control coefficients of the magnetic bearings associated with the type of the new rolling bearing ring from among the plurality of sets of control coefficients of the magnetic bearings, and
repeating the dressing and grinding steps, the magnetic bearings being respectively controlled on the basis of the coefficients of the first list of control coefficients and of the coefficients of the second list of control coefficients associated with the type of the new rolling bearing ring.

Preferably, the installation step further comprises installing a new grinding wheel associated with the new rolling bearing ring, the magnetic bearings being respectively controlled on the basis of the coefficients of the first list of control coefficients and of the coefficients of the second list of control coefficients associated with the type of the new grinding wheel and with the type of the new rolling bearing ring.

Advantageously, the method comprises repeating the grinding step for the same type of rolling bearing ring, the surface of a different rolling bearing ring of said type being ground with each repetition, the method further comprising incrementing a counter with each repetition, and repeating the dressing step once the counter has reached a predetermined threshold value.

Preferably, the method comprises determining driving values for the radial bearings and for the axial bearing on the basis of servocontrol means that are parametrized on the basis of the first and second lists of control coefficients.

Also proposed is a device for controlling a spindle of a grinding machine, the spindle comprising a rotor supported by two radial magnetic bearings and one axial bearing, the rotor comprising a grinding wheel for grinding a surface of a rolling bearing ring.

The device comprises:
a storage means, which are configured to store a plurality of sets of control coefficients of the magnetic bearings, each set of control coefficients of the magnetic bearings being associated with a different type of grinding wheel and of rolling bearing ring, and comprising a first list of control coefficients and a second list of control coefficients,
a means for determining the type of the grinding wheel and of the rolling bearing ring,
a selection means, which are configured to select a set of control coefficients of the magnetic bearings associated with the determined types of grinding wheel and of the rolling bearing ring from among the plurality of sets of control coefficients stored in the storage means, and
a means for controlling the radial and axial magnetic bearings, said means being configured to control, during a dressing step, the radial and axial magnetic bearings on the basis of the coefficients of the first list of control coefficients associated with the set of coefficients of the determined type of the grinding wheel and of the rolling bearing ring, and being configured to control, during a grinding step, the radial and axial magnetic bearings on the basis of the control coefficients of the second list of coefficients associated with the set of coefficients of the determined type of grinding wheel and of rolling bearing ring.

Advantageously, the device further comprises a counter, which is configured to be incremented once a different rolling bearing ring of the same type has been ground, the control means being configured to control, during the dressing step, the radial and axial magnetic bearings on the basis of the control coefficients of the first list of coefficients associated with the set of coefficients of the type of grinding wheel and of the rolling bearing ring once the counter has reached a predetermined threshold value.

Preferably, the control means comprise servocontrol means, which are configured to determine control values for the radial bearings and for the axial bearing on the basis of the first and second lists of control coefficients.

Advantageously, the determination means comprise a human-machine interface.

Also proposed is a grinding machine, which comprises a spindle comprising a rotor supported by two radial magnetic bearings and one axial bearing, the rotor comprising a grinding wheel for grinding a surface of a rolling bearing ring, and a control device as defined above, which is connected to the radial magnetic bearings and to the axial bearing.

### BRIEF DESCRIPTION OF THE DRAWINGS

Further aims, features and advantages of the present disclosure will become apparent from reading the following description, which is given purely by way of non-limiting example and with reference to the appended drawings, in which:

FIG. 1 is a perspective of a part of a grinding machine according to the present disclosure;

FIG. 2 is a schematic diagram of a spindle of the grinding machine according to the present disclosure;

FIG. 3 is a schematic diagram of a control device according to the present disclosure;

FIG. 4 is a schematic arrangement of a storage means according to the present disclosure;

FIG. 5 is a schematic diagram of a means for servocontrolling a radial magnetic bearing according to the present disclosure; and

FIG. 6 is a flow diagram for a method for controlling the spindle according to the present disclosure.

### DETAILED DESCRIPTION

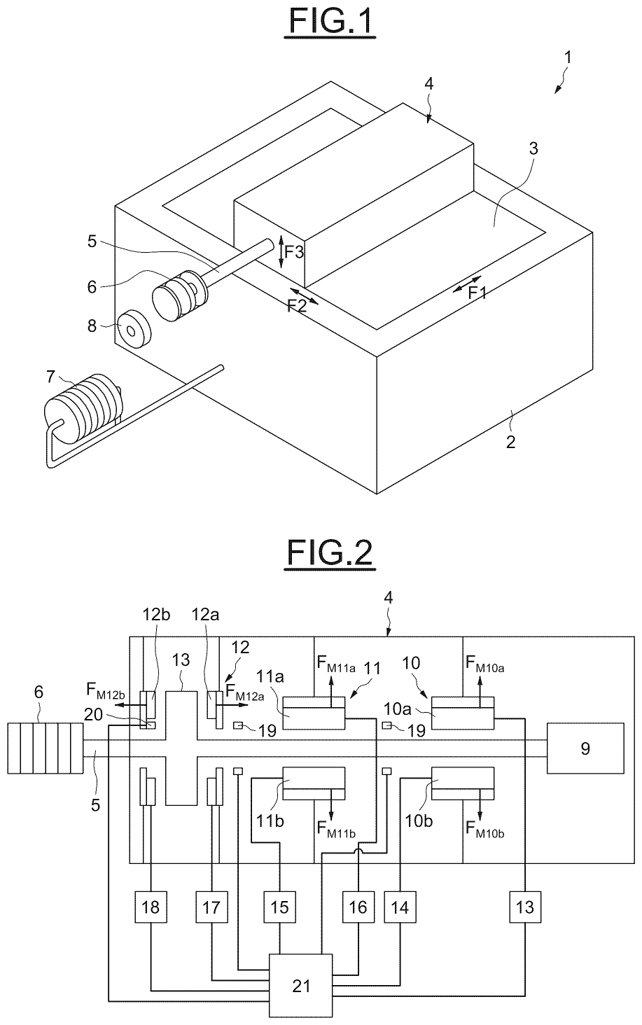

Reference is made to FIG. 1, which schematically shows an example of a grinding machine 1 comprising a frame 2, a table 3, and a spindle 4 secured to the table 3.

The table 3 is able to move in translation relative to the frame 2 with three degrees of freedom, as represented by arrows F1, F2, F3.

The spindle 4 comprises a rotor 5, one of the ends of which is equipped with a grinding wheel 6.

The grinding machine 1 further comprises a dressing tool 7 for shaping the grinding wheel 6.

A rolling bearing ring 8 is guided and driven in rotation by a guiding and rotating device (not shown) such that the grinding wheel 6 grinds a surface of the rolling bearing ring 8 during a grinding phase.

The ring 8 and the grinding wheel 6 associated with said ring 8 are assumed to be of the type T1.

The grinding machine 1 grinds rings of different types, each type being identified by the reference Tn, n being an integer greater than or equal to one.

Reference is made to FIG. 2, which schematically shows an exemplary embodiment of the spindle 4.

The spindle 4 comprises an electric motor 9 that drives the rotor 5.

The rotor 5 is held in a stator of the spindle 4 by two radial magnetic bearings 10, 11 and one axial magnetic bearing 12.

In FIG. 2, for the sake of clarity, each radial magnetic bearing 10, 11 comprises one pair of stator coils 10a, 10b, 11a, 11b that are diametrically opposed and form a servocontrol axis.

Of course, each radial magnetic bearing 10, 11 may comprise more than one pair of stator coils, each pair of stator coils being diametrically opposed.

For example, each magnetic bearing may comprise two perpendicular servocontrol axes, which are each formed by a pair of stator coils.

The stator coils 10a, 10b, 11a, 11b extend in a direction that is parallel to the axis of rotation of the rotor 5.

The axial bearing 12 comprises two annular stator coils 12a, 12b through which the rotor 5 passes, and a disc 13 that is secured to the rotor 5 and arranged between the two annular stator coils 12a, 12b.

Each stator coil 10a, 10b, 11a, 11b and each annular stator coil 12a, 12b is connected to a different current amplifier 13, 14, 15, 16, 17, 18.

The current amplifiers 13, 14, 15, 16, 17, 18 are made from semiconductors.

Each current amplifier 13, 14, 15, 16 supplies power to the stator coil 10a, 10b, 11a, 11b such that said stator coil generates a magnetic force FM10a, FM10b, FM11a, FM11b that attracts the rotor 5.

Each current amplifier 17, 18 supplies power to the annular stator coil 12a, 12b such that said annular stator coil generates a magnetic force FM12a, FM12b that attracts the disc 13.

The spindle 4 further comprises position sensors 19, 20.

Each servocontrol axis comprises a first sensor 19 that measures the radial position of the rotor 5.

A second sensor 20 measures the axial position of the rotor 5.

For example, the first and second sensors 19, 20 are inductive, capacitive or eddy-current sensors.

The current amplifiers 13, 14, 15, 16, 17, 18 are driven by a control device 21.

The first and second sensors 19, 20 are connected to the control device 21.

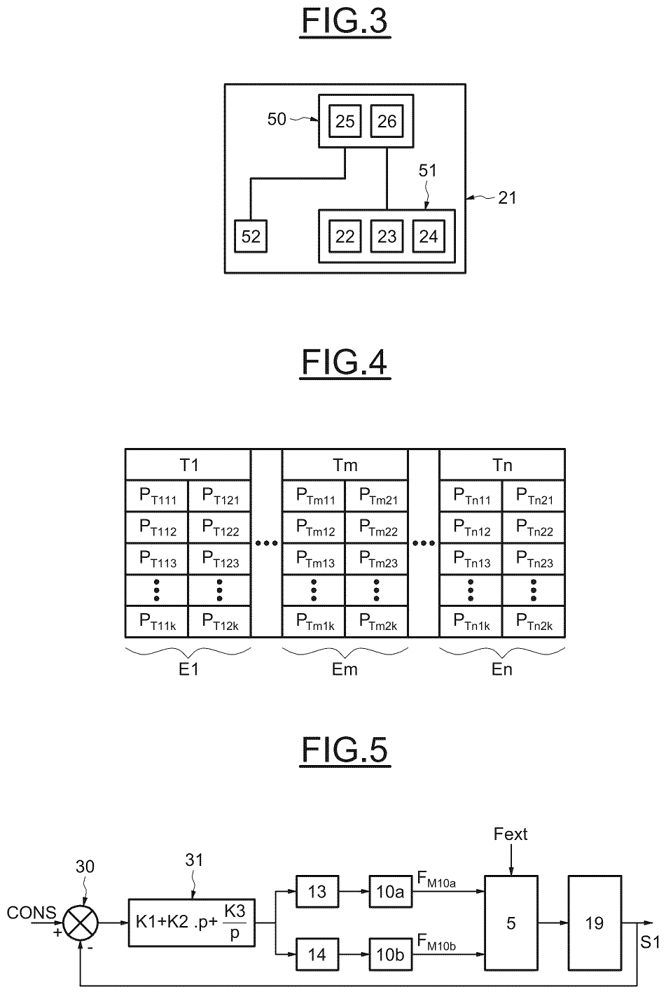

FIG. 3 schematically shows an exemplary embodiment of the control device 21.

The control device 21 comprises a programmable controller 50, which comprises, for example, a programmable logic controller, a magnetic bearing controller 51, and a control unit 52 for the electric motor 9.

The control unit 52 comprises, for example, a variable frequency drive (VFD).

The programmable controller 50 is connected to the magnetic bearing controller 51 and to the control unit 52, and comprises means for determining the type of the rolling bearing ring 8.

The determination means comprise, for example, a human-machine interface, such as a selection screen 25.

The programmable controller 50 further comprises a counter 26.

The magnetic bearing controller 51 comprises storage means 22, selection means 23 and control means 24.

The storage means 22 comprise, for example, a non-volatile memory, for example a flash-type electrically erasable programmable read-only memory (EEPROM).

The control means 24 are able to drive the current amplifiers 13, 14, 15, 16, 17, 18 on the basis of the measurements output from the sensors 19, 20, on the basis of the type of the ring 8 provided by the determination means, and on the basis of control coefficients of the magnetic bearings output from the selection means 23 and stored in the storage means 22.

The counter 26 counts the number of rings of the same type that have been ground by the grinding wheel 6.

The programmable controller 50 further comprises means for controlling the table 3, which are not shown and drive the table 3 in translation in the three directions F1, F2, F3.

The control unit 52 controls the motor 9 on the basis of instructions received from the programmable controller 50. FIG. 4 shows an exemplary arrangement of the storage means 22.

The storage means 22 store, for each type T1 to Tn of ring, a set E1 to En of control coefficients of the magnetic bearings.

Each set E1 to En of control coefficients comprises a first list [PT111 to PT11k], [PTm11 to PTm1k], [PTn11 to PTn1k] and a second list [PT121 to PT12k], [PT121 to PT12k], [PT121 to PT12k], k being an integer greater than 1.

The control means comprise servocontrol means, which are able to determine control values for the radial bearings 10, 11 and for the axial bearing 12 on the basis of the first and second lists [PT111 to PT11k], [PTm11 to PTm1k], [PTn11 to PTn1k], [PT121 to PT12k], [PT121 to PT12k], [PT121 to PT12k] of control coefficients.

As the means for servocontrolling the radial bearings 10, 11 and the axial bearing 12 all have the same architecture, just one schematic example of the means for servocontrolling the radial bearing 10 is shown in FIG. 5.

The servocontrol means comprise a regulation loop comprising a comparator 30.

The comparator 30 comprises an addition input that receives a setpoint CONS and a subtraction input.

The regulation loop further comprises a corrector 31, for example a proportional-integral-derivative (PID) corrector, which comprises an input connected to an output of the comparator 30 and an output connected to a control input of the current amplifiers 13, 14 that supply power to the coils 10a, 10b.

The PID controller 31 comprises servocontrol parameters, which comprise, for example, a proportional gain K1, an integral gain K2, and a derivative gain K3.

The values of the gains K1, K2, K3 are determined on the basis of the sets E1 to En of control coefficients as described below.

Each coil 10a, 10b generates the magnetic force FM10a, FM10b acting on the rotor 5, the magnetic forces FM10a, FM10b being in opposite directions to one another.

Furthermore, the rotor 5 is subjected to external forces Fext that are mainly generated by the grinding wheel 6 and by gravity (weight of the rotor 5).

The sensor 19 measures the radial position of the rotor 5, which is subjected to the resultant of the magnetic forces FM10a, FM10b and of the external forces Fext, and outputs a signal S1 that is representative of the position of the rotor 5 in the bearing 10.

The signal S1 is supplied to the subtraction input of the comparator 30.

The setpoint CONS is chosen so that the axis of rotation of the rotor 5 is coincident with the central axis of the bearing 10.

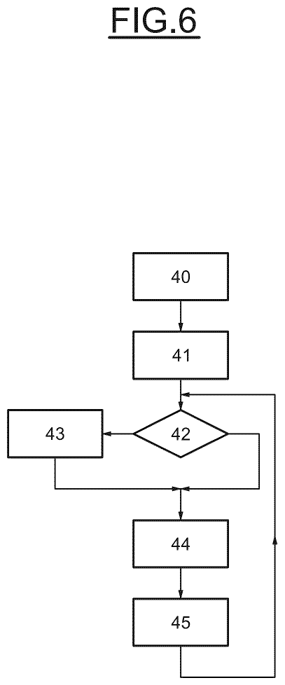

FIG. 6 shows an example of a method for controlling the spindle 4.

The grinding machine 1 is assumed to begin a production cycle with the counter 26 being reset to zero, and with the ring 8 being arranged in the holding device in order to be ground.

During a step 40 of determining the type of the rolling bearing ring, the determination means determine the type T1 of the ring 8.

The type of the ring 8 is specified by an operator via the screen 25.

Alternatively, the type of the ring 8 is determined by the determination means on the basis of the production programme.

The programmable controller 50 supplies the type T1 to the selection means 23.

During a selection step 41, the selection means 23 select the set E1 of control coefficients that is stored in the storage means 22 and associated with the types T1 of the grinding wheel 6 and of the ring 8 that are determined by the determination means.

Then, during a step 42, as the grinding wheel 6 has not ground any rings, the counter 26 outputs a zero value and the method continues to a dressing step 43.

During the dressing step 43, the programmable controller 50 controls the selection means 23 such that the selection means 23 select the coefficients PT111 to PT11k of the first list of control coefficients of the first set E1 and assign the value of said coefficients to the servocontrol parameters driving the current amplifiers 10, 11, 12.

The magnetic bearing controller 51 drives the magnetic bearings 10, 11, 12 on the basis of the coefficients PT111 to PT11k of the first list of control coefficients of the first set E1, the programmable controller 50 drives the table 3 and the control unit 52 drives the motor 9 such that the grinding wheel 6 is shaped by the dressing tool 7.

The counter 26 is incremented by one unit.

Then, during a step 44, as the counter 26 has output a non-zero value, the programmable controller 50 controls the selection means 23 such that the selection means 23 select the coefficients PT121 to PT12k of the second list of control coefficients of the first set E1 and assign the value of said coefficients to the servocontrol parameters driving the current amplifiers 10, 11, 12.

The magnetic bearing controller 51 drives the magnetic bearings 10, 11, 12 on the basis of the coefficients PT121 to PT12k of the second list of control coefficients of the first set E1, the programmable controller 50 drives the table 3 and the control unit 52 drives the motor 9 such that the grinding wheel 6 grinds the surface of the rolling bearing ring 8.

During a step 45, once the surface of the rolling bearing ring 8 has been ground, the ring 8 is removed from the holding device and replaced by another ring of the type T1.

Furthermore, the counter 26 is incremented by one unit.

As long as the counter 26 has not reached a predetermined threshold value (step 42), the method continues to step 44.

Once the counter has reached the predetermined threshold value (step 42), the counter 26 is reset and the method continues to the dressing step 43.

The predetermined threshold value is, for example, equal to five, so that once five type T1 ring surfaces have been ground, the grinding wheel 6 is dressed, which makes it possible to ensure a consistent grinding quality.

The method may further comprise a step of installing a new rolling bearing ring of a type that is different to the type T1 of the rolling bearing ring 8 determined during the step of determining the type of rolling bearing ring.

Once the new rolling bearing ring has been installed, the method restarts at step 40.

The sets E1 to En may further comprise, in each of the lists, sensitivity factors for the sensors in the spindle 4, predetermined threshold alarm values in order to provide a warning in the event of the spindle 4 malfunctioning, and operating mode parameters of the spindle 4, for example depending on a critical speed-shift mode of the rotor 5 or an automatic balancing mode of the rotor 5, the selection means 23 furthermore selecting these values depending on the dressing or grinding operating mode of the grinding wheel 6.

1. A method for controlling a spindle of a grinding machine, the spindle comprising a rotor supported by two radial magnetic bearings and one axial bearing, the rotor comprising a grinding wheel for grinding a surface of a rolling bearing ring, the method comprising:
a step of determining the type of the rolling bearing ring,
a step of selecting a set of control coefficients of the magnetic bearings associated with the types of rolling bearing ring determined from among a plurality of sets of control coefficients of the magnetic bearings, each set of control coefficients of the magnetic bearings being associated with a different type of grinding wheel and of rolling bearing ring, and comprising a first list of control coefficients and a second list of control coefficients,
a dressing step, which comprises dressing the grinding wheel using a dressing tool, the magnetic bearings being controlled on the basis of the coefficients of the first list of control coefficients associated with the set of coefficients of the determined type of the grinding wheel and of the rolling bearing ring, and
a step of grinding the raceway of the rolling bearing ring using the dressed grinding wheel, the magnetic bearings being controlled on the basis of the coefficients of the second list of control coefficients associated with the set of coefficients of the determined type of rolling bearing ring.

2. The method according to claim 1, comprising:
a step of installing a new rolling bearing ring of a type that is different to the type of the rolling bearing ring determined during the step of determining the type of rolling bearing ring,
repeating the selection step in order to select the set of control coefficients of the magnetic bearings associated with the type of the new rolling bearing ring from among the plurality of sets of control coefficients of the magnetic bearings, and
repeating the dressing and grinding steps, the magnetic bearings being respectively controlled on the basis of the coefficients of the first list of control coefficients and of the coefficients of the second list of control coefficients associated with the type of the new rolling bearing ring.

3. The method according to claim 2, wherein the installation step further comprises installing a new grinding wheel associated with the new rolling bearing ring, the magnetic bearings being respectively controlled on the basis of the coefficients of the first list of control coefficients and of the coefficients of the second list of control coefficients associated with the type of the new grinding wheel and with the type of the new rolling bearing ring.

4. The method according to claim 1, comprising repeating the grinding step for the same type of rolling bearing ring, the surface of a different rolling bearing ring of said type being ground with each repetition, the method further comprising incrementing a counter with each repetition, and repeating the dressing step once the counter has reached a predetermined threshold value.

5. The method according to claim 1, comprising determining driving values for the radial bearings and for the axial bearing on the basis of servocontrol means that are parametrized on the basis of the first and second lists of control coefficients.

6. The method according to claim 3, comprising repeating the grinding step for the same type of rolling bearing ring, the surface of a different rolling bearing ring of said type being ground with each repetition, the method further comprising incrementing a counter with each repetition, and repeating the dressing step once the counter has reached a predetermined threshold value.

7. The method according to claim 6, comprising determining driving values for the radial bearings and for the axial bearing on the basis of servocontrol means that are parametrized on the basis of the first and second lists of control coefficients.

8. A device for controlling a spindle of a grinding machine, the spindle comprising a rotor supported by two radial magnetic bearings and one axial bearing, the rotor comprising a grinding wheel for grinding a surface of a rolling bearing ring, the device comprising:
a storage means configured to store a plurality of sets of control coefficients of the magnetic bearings, each set of control coefficients of the magnetic bearings being associated with a different type of grinding wheel and of rolling bearing ring, and comprising a first list of control coefficients and a second list of control coefficients,
a means for determining the type of the grinding wheel and of the rolling bearing ring,
a selection means configured to select a set of control coefficients of the magnetic bearings associated with the determined types of grinding wheel and of rolling bearing ring from among the plurality of sets of control coefficients stored in the storage means, and
a means for controlling the radial and axial magnetic bearings, said means being configured to control, during a dressing step, the radial and axial magnetic bearings on the basis of the coefficients of the first list of control coefficients associated with the set of coefficients of the determined type of grinding wheel and of rolling bearing ring, and being configured to control, during a grinding step, the radial and axial magnetic bearings on the basis of the control coefficients of the second list of control coefficients associated with the set of coefficients of the determined type of grinding wheel and of rolling bearing ring.

9. The device according to claim 8, further comprising a counter, which is configured to be incremented once a different rolling bearing ring of the same type has been ground, the control means being configured to control, during the dressing step, the radial and axial magnetic bearings on the basis of the coefficients of the first list of control coefficients associated with the set of coefficients of the type of grinding wheel and of rolling bearing ring once the counter has reached a predetermined threshold value.

10. The device according to claim 8, wherein the control means comprises a servocontrol means configured to determine control values for the radial bearings and for the axial bearing on the basis of the first and second lists of control coefficients.

11. The device according to claim 8, wherein the determination means comprises a human-machine interface.

12. The device according to claim 9, wherein the control means comprises a servocontrol means configured to determine control values for the radial bearings and for the axial bearing on the basis of the first and second lists of control coefficients.

13. The device according to claim 12, wherein the determination means comprises a human-machine interface.

14. A grinding machine comprising:
a spindle comprising a rotor supported by two radial magnetic bearings and one axial bearing, the rotor comprising a grinding wheel for grinding a surface of a rolling bearing ring; and
a control device according to claim 13, which is connected to the radial magnetic bearings and to the axial bearing.

15. A grinding machine comprising:
a spindle comprising a rotor supported by two radial magnetic bearings and one axial bearing, the rotor comprising a grinding wheel for grinding a surface of a rolling bearing ring; and
a control device according to claim 8, which is connected to the radial magnetic bearings and to the axial bearing.
